(19) United States
(12) Patent Application Publication
(10) Pub. No.: US 2004/0039754 A1
(43) Pub. Date: Feb. 26, 2004

(54) Method and system for cataloging and managing the distribution of distributed digital assets

(76) Inventor: Daniel L. Harple JR., South Dartmouth, MA (US)

Correspondence Address: HALE AND DORR, LLP, 60 STATE STREET, BOSTON, MA, 02109

(21) Appl. No.: 10/449,159

(22) Filed: May 30, 2003

Related U.S. Application Data
(60) Provisional application No. 60/385,291, filed on May 31, 2002.

(51) Int. Cl. G06F 7/00

(52) U.S. Cl. 707/104.1

(57) ABSTRACT

A method and system are provided for integrating and managing the distribution of content items residing at multiple disparate content repositories. The system includes an integration module for receiving metadata relating to the content items from one or more content providers, a content module for managing the metadata, and a distribution module for controlling distribution of the content items to one or more content destinations. The method includes receiving metadata relating to the content items from one or more content providers, managing the metadata, and managing distribution of the content items to one or more content destinations.

### RELATED APPLICATION

The present application is based on and claims priority from U.S. Provisional Patent Application Serial No. 60/385,291 filed on May 31, 2002 and entitled “METHOD AND SYSTEM FOR CATALOGING AND MANAGING THE DISTRIBUTION OF DIGITAL ASSETS,” the specification of which is incorporated herein by reference in its entirety.

### BACKGROUND OF THE INVENTION

1. Field of the Invention

The present invention relates generally to digital content management and, more particularly, to a method and system for distributed cataloging of distributed content, and managing multi-device and multi-channel distribution of such content, with concurrent enterprise support for multiple vendors' application servers, databases and content and asset management systems.

2. Description of Related Art

Large organizations and enterprises typically have very large quantities of digital assets such as multimedia, text, application files, image, video and audio content. These assets are typically stored in disparate sources (file systems, content management systems, asset management systems, web sites, etc.) in different formats across the enterprise. For example, the assets can exist in various formats on different machines in different divisions of a company. It is accordingly generally very difficult to locate, categorize, manage and effectively utilize all such assets of the organization. It is, e.g., difficult to find and aggregate content from disparate sources. It is also difficult to effectively collaborate with this content, and to share, distribute, and provide automated distribution and syndication methods of the content to, e.g., other organizations, the enterprise intranet, partner extranets, and publishing networks.

Digital asset management systems and content management systems have been developed to address these problems. These systems generally require the digital assets of an organization to be moved to a centralized storage system and cataloged to make them accessible to users. Implementation of such systems is, however, very expensive, complex, and time consuming.

A need exists for an improved method and system for locating, managing and distributing digital assets, especially in a massively distributed environment such as that provided on the Internet, intranets and extranets.

### BRIEF SUMMARY OF EMBODIMENTS OF THE INVENTION

In accordance with one or more embodiments of the invention, a content integration system is provided for integrating and managing the distribution of content items residing at multiple disparate content repositories. The system includes an integration module for receiving metadata relating to the content items from one or more content providers, a content module for managing the metadata, and a distribution module for controlling distribution of the content items based on the metadata to one or more content destinations.

In accordance with one or more embodiments of the invention, a method is provided for integrating and managing the distribution of content items residing at multiple disparate content repositories. The method includes the steps of receiving metadata relating to the content items from one or more content providers, managing the metadata, and managing distribution of the content items based on the metadata to one or more content destinations.

In accordance with one or more embodiments of the invention, a method is provided for virtually centralizing digital assets stored in a plurality of remote content repositories and controlling distribution of the digital assets. The method includes receiving metadata relating to the digital assets from one or more content providers, cataloging the metadata, providing access to users to cataloged metadata, and managing distribution of the digital assets based on the metadata to one or more content destinations.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense.

### BRIEF DESCRIPTION OF THE DRAWINGS

For a fuller understanding of the nature and objects of various embodiments the present invention, reference should be made to the following detailed description taken in connection with the accompanying drawings wherein:

FIG. 1 is a simplified block diagram illustrating use of a content integration system in accordance with one or more embodiments of the invention;

FIG. 2 is a simplified block diagram illustrating the general architecture of a content integration system in accordance with one or more embodiments of the invention;

FIG. 3 is a simplified block diagram illustrating automatic importing of distributed digital content and digital metadata to a content integration system in accordance with one or more embodiments of the invention;

FIG. 4 is a schematic diagram illustrating authoring for multi-channel and multi-device presentations in accordance with one or more embodiments of the invention; and

FIG. 5 is a schematic diagram illustrating distributed content delivery, concurrently to multiple end users with multiple platforms and devices in accordance with one or more embodiments of the invention.

### DETAILED DESCRIPTION OF PREFERRED EMBODIMENTS

The present invention is generally directed to methods and systems for distributed cataloging and managing and distribution of digital content across networks such as, e.g., the Internet (particularly the World Wide Web) and Intranets.

As is well known, the World Wide Web contains an extremely large collection of online information. This information resides on a number of web servers and includes digital content such as multimedia text, images and graphics, video and sounds. The online information can be stored in the form of electronic documents having a standard format referred to as hypertext markup language (HTML). HTML documents can be accessed and interpreted by a browser on a user terminal device. The location of electronic files on the Internet can be specified by a link referred to as a uniform resource locator (URL) or, more generally, a uniform resource identifier (URI). Some HTML documents contain links (e.g., hyperlinks) to other HTML documents whether on the same web server or on any other server connected to the Internet. A user can generally view a document having such links as a seamless whole even though portions of that document might be located on a multiple web servers.

One or more embodiments of the present invention are directed to a content integration system that allows the digital content or assets of organizations to be easily and efficiently cataloged, aggregated, packaged and distributed, leveraging their inherently decentralized, distributed nature. The content integration system is particularly suitable for use by entities or widely distributed enterprises such as, e.g., media and other companies, having large numbers of digital assets. The terms digital assets and digital content refer to content (such as, e.g., text, graphics, images, sound and video information) in files that can be electronically transmitted.

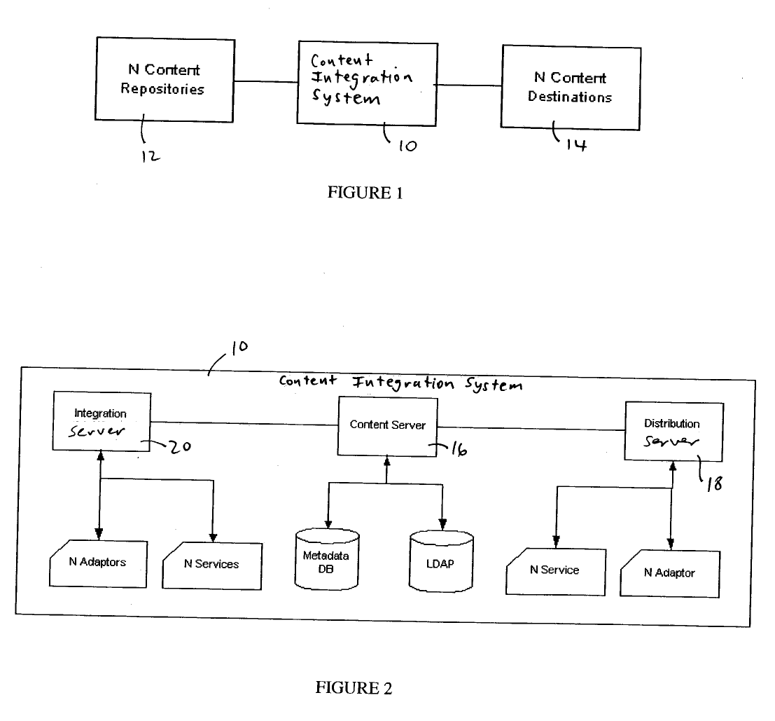

FIG. 1 is a simplified block diagram illustrating one possible implementation of a content integration system 10 in accordance with one or more embodiments of the invention, namely in a multi-partner and channel syndication content distribution system. The content integration system 10 stores and manages metadata and/or content relating to content from one or more content providers through one or more content repositories 12. The content integration system 10 can control integration and delivery of content from the content repositories 12 to one or more content destinations 14 by associating business rules to the content and enforcing the rules during content delivery. The content repositories 12 can be located on any network including, e.g., content provider networks and content delivery networks. The content destinations 14 can, e.g., be content subscriber networks and end user terminals.

The content itself is not necessarily stored in the content integration system 10. Instead, the content can be stored in the content repositories 12, which can include various external file systems, digital asset management systems, and content management systems, thereby leveraging current investments in information technology infrastructure. The content integration system 10 can facilitate use and re-use of the content, while allowing the content to reside at its decentralized, disparate locations.

The content integration system 10 can be used with multiple content repositories 12, content delivery networks, subscriber networks, and end user destinations. For example, the content integration system 10 can control distribution of content packages containing content objects from multiple different content providers, file systems, content management systems, asset management systems, web sites, etc.

The content integration system 10 stores and manages metadata relating to content from content providers. Metadata defines characteristics of content objects and any rules associated with the use of that content. For example, metadata can describe (1) the parameters and characteristics of the content, (2) the source of the content, (3) business rules for the use of the content, and/or (4) presentation rules for the display of the content. The particular type of metadata used can be extended as desired by system users.

System users can input metadata values manually, or the values can be derived automatically from the content storing systems on, e.g., a scheduled basis.

Using the metadata, the content integration system 10 can catalog enterprise digital assets in a virtual repository to provide a unified view of enterprise content. The content integration system 10 can include library services that enable system users to find desired content from the distributed content metadata catalogs. The content integration system 10 can support the creation and browsing of content hierarchies using simple or complex searching. As such, the content integration system can be considered a “content switch” utilizing the metadata to provide access to widely distributed content. This contextual switching process enables context-specific content delivery to multiple content destinations including multiple end users.

By cataloging metadata of disparate or distributed digital assets, the content integration system 10 allows users to create virtual private content networks (VPCNs) that virtually centralize digital assets and facilitate the sharing and collaboration thereof. Content can be distributed on different suites, devices and channels to the enterprise and to external users (such as partners and customers) in a VPCN.

A database on the content integration system 10 for storing metadata can include metadata from multiple content providers. For security purposes, the database can be partitioned into domains for respective content providers.

The content integration system 10 can include packaging services that allow creation of content packages of one or more digital assets, along with business rules for their use and Web page templates for their display. One example of a package is a Web page containing content items from one or more content repositories 12. The templates can include one or more placeholders that are mapped by the content integration system 10 with corresponding content items, which can be from different sources. Packaging can be dynamically performed, i.e., the content items for a package can be selected upon receiving a request for the package.

The content integration system 10 allows companies to manage the sharing and distribution of content internally to a company or externally (e.g., to affiliate entities or through public portals or marketplaces). The content integration system 10 can control who receives the content and in what form. To manage distribution of digital assets, the content integration system 10 associates business rules to the content, and enforces the rules during delivery of the content. Business rules can specify, e.g., access, licensing, valuation, and presentation requirements of the content. For example, business rules can specify the price (e.g., base price or pay-per-view price), duration of use or expiration, geographic distribution limitations, and associated license information.

The content integration system 10 can perform hierarchical rights management for content packages having content items with different associated rights. In one example of hierarchical rights management, the most restrictive rights for any item apply to the entire package. For example, if a content package includes three content items, only one of which contains a geographical distribution limitation, then that limitation will apply to the entire package.

The content integration system 10 can also track content reach and use. It can issue customizable reports on how content is used, e.g., internally within an organization or by distribution partners and/or end users.

System users can access the content integration system 10 through a browser based or client based user interface.

The content integration system 10 can significantly lower the cost and reduce the time needed for enterprise content management. In addition, its implementation involves only minimal disruption to existing processes.

FIG. 2 is a simplified block diagram providing an architectural overview of an content integration system 10 in accordance with one or more embodiments of the invention. As shown, the content integration system 10 can contain various software modules or server components including a content server 16, a distribution server 18, an integration server 20. The features of the servers depicted in FIG. 2 can also be presented via or to a web services based framework.

The integration server 20 aids content providers in providing distributed metadata to the content integration system 10. In particular, the integration server 20 can manage and facilitate the process and work flow associated with importing metadata into the content integration system 10.

The content server 16 manages the metadata of content objects, the creation of packages combining content objects and business terms, and the access to those packages.

The distribution server 18 enables scalable content delivery. The distribution server 18 can authorize access to packages according to their business terms. This can include the delivery of web templates containing content and presentations for one or more content objects, concurrently to multiple VPCN parties, devices, suites, and channels.

The distribution server 18 can also include an authoring interface, which provides a web or client based view of content acquired and authorized for use. The authoring interface can include various tools to simplify integration of the content integration system into various web authoring environments.

The distribution server 18 can also provide distributed delivery management. For example, it can verify VPCN relationships and resolve web templates before delivery. It can also provide geographic blocking and geographic targeting capability.

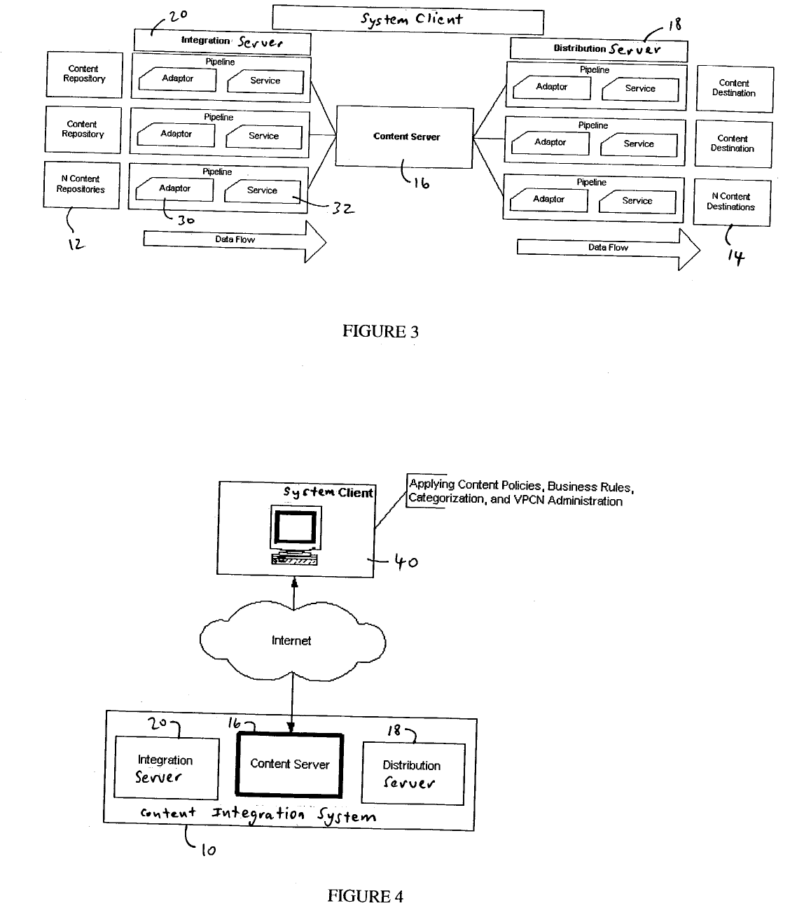

FIG. 3 illustrates automated importation of distributed metadata into the content integration system 10 from a content provider network of an enterprise. Content is aggregated via adaptors at a content provider network from multiple content sources 12. The adaptors can, e.g., be agent-based clients that import files, collections of files or feeds of content into the content integration system 10. The metadata associated with the content is extracted and then normalized. The metadata is then categorized using a categorization service. The categorized metadata is then imported into the content integration system 10 through the integration server 20. Metadata can be imported into the content integration system 10 in various ways including, e.g., bulk, synchronized and manual importation.

The metadata is then migrated from the integration server 20 into the content server 16. The digital assets associated with the metadata are transported to one or more content delivery networks via adaptors for distribution.

FIG. 3 illustrates use of the content integration system 10 to facilitate N-tiered, multi-threaded parallel processing of content in a highly scalable manner. Integration server 20 manages the N-tiered multi-threaded aggregation of N content repositories with adaptors. The integration server 20 provides a parallel processing pipeline process enabling scheduling of the adaptors 30 and subsequent services 32 processing in a manner that preferably maximizes throughout. Content server 16 provides unified view access to all virtually aggregated content. The distribution server 18 can manage the N-tiered multi-threaded contextual delivery of content to N content destinations as previously described.

Once content has been processed through the system, it is available for distribution. Subscription to content can be an automated or manual process, and the content can be accessible to clients in both a push or pull fashion.

FIG. 4 illustrates use of an authoring interface provided by the content integration system 10. N end users can log into the content integration system 10 via, e.g., a web browser or other client 40 to gain access to the content galleries from which they can author. Production teams can integrate metadata, web templates, or assets into their presentation pages.

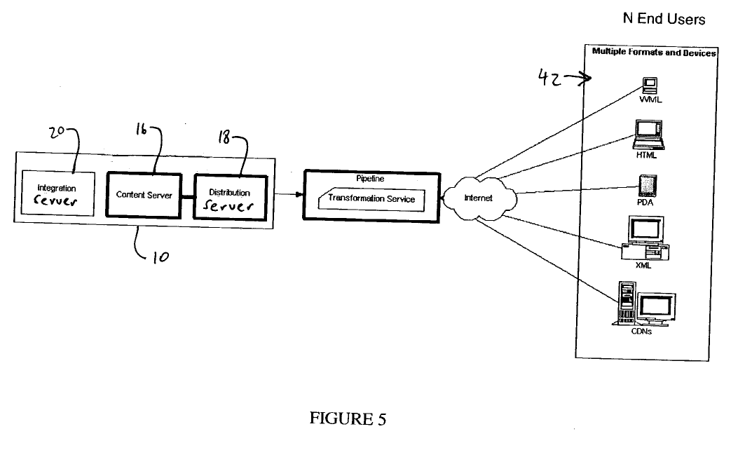

FIG. 5 illustrates an example of use of the content integration system 10 to deliver content to an N end users running exemplary multiple platforms and devices 42. A request for a digital asset made by an end user re-routes the end user to the distribution server 18 on the content integration system 10. The distribution server 18 validates the parameters of the request, and redirects the user to the location of the digital asset on a content delivery network. The content delivery network then delivers the content to the user.

Requests made for web templates also re-routes the end user to the distribution server 18 on the content integration system 10. The distribution server 18 validates the parameters of the request, and returns the appropriate content in the context of the template to the end user.

The content integration system 10 utilizes content object representation. Using data representation, multiple digital manifestations of a single logical content asset can be stored, acquired, and used in a way that allows, e.g., the most appropriate manifestation of that content to be automatically selected and delivered according to the characteristics of the content, content metadata, and/or delivery suite.

The content integration system 10 can also provide automatic subscription to content delivery networks. This is the process by which content that is represented/managed in the content integration system can be automatically made available (subject to rules) to users/subscribers via multiple heterogeneous content delivery networks to which the content integration system has built in interfaces.

The content integration system 10 can also include a process for automatic generation of taxonomies. The content integration system 10 can automatically generate, based on available content metadata, categorization and taxonomy of content that is imported into the content integration system via the integration server 20.

Having described preferred embodiments of the present invention, it should be apparent that modifications can be made without departing from the spirit and scope of the invention.

1. A content integration system for integrating and managing the distribution of content items residing at a plurality of disparate content repositories, comprising:
an integration module for receiving metadata relating to said content items from one or more content providers;
a content module for managing the metadata; and
a distribution module for controlling distribution of said content items based on the metadata to one or more content destinations.

2. The system of claim 1 wherein the integration module manages multi-threaded processing of metadata received from a plurality of said content providers.

3. The system of claim 2 wherein said integration module optimizes throughput of metadata from a plurality of said content providers.

4. The system of claim 1 wherein said content module generates packages of content items and business terms related to said content items.

5. The system of claim 1 wherein said distribution module authorizes access to said content items in accordance with business terms associated with said content items.

6. The system of claim 1 wherein said distribution module further includes an authoring interface for allowing system users to view content authorized for use.

7. The system of claim 1 wherein said content module catalogs said metadata.

8. The system of claim 1 wherein said content module allows users to virtually centralize digital assets.

9. The system of claim 1 wherein said distribution module manages multi-threaded delivery of content items to a plurality of content destinations.

10. The system of claim 1 wherein the integration module further receives one or more content items from said one or more content providers, the content module further manages the received content items, and the distribution module further controls distribution of the received content items.

11. A method of integrating and managing the distribution of content items stored at a plurality of disparate content repositories, comprising:
receiving metadata relating to said content items from one or more content providers;
managing the metadata; and
managing distribution of said content items based on said metadata to one or more content destinations.

12. The method of claim 11 further comprising managing multi-threaded processing of metadata received from a plurality of said content providers.

13. The method of claim 12 further comprising optimizing throughput of metadata from a plurality of said content providers.

14. The method of claim 11 further comprising aggregating a plurality of content items in packages with business terms related to said content items.

15. The method of claim 11 further comprising authorizing access to said content items in accordance with business terms associated with said content items.

16. The method of claim 11 wherein managing the metadata comprises cataloging the metadata.

17. The method of claim 11 further comprising receiving one or more content items from said one or more content providers, managing the received content items, and controlling distribution of the received content items.

18. A method of virtually centralizing digital assets stored in a plurality of remote content repositories and controlling distribution of said digital assets, comprising:
receiving metadata relating to said digital assets from one or more content providers;
cataloging the metadata;
providing access to users to cataloged metadata; and
managing distribution of said digital assets based on said metadata to one or more content destinations.

19. The method of claim 18 further comprising managing multi-threaded processing of metadata received from a plurality of said content providers.

20. The method of claim 19 further comprising optimizing throughput of metadata from a plurality of said content providers.

21. The method of claim 18 further comprising aggregating a plurality of digital assets in packages with business terms related to said digital assets.

22. The method of claim 18 further comprising authorizing access to said digital assets in accordance with business terms associated with said digital assets.

23. The method of claim 18 further comprising receiving one or more digital assets from said one or more content providers, managing the received digital assets, and controlling distribution of the received digital assets.
